(19) United States
(12) Patent Application Publication
(10) Pub. No.: US 2026/0138248 A1
(43) Pub. Date: May 21, 2026

(54) HYBRID ELECTROMECHANICAL TORQUE WRENCH

(71) Applicant: Creative Systems and Design, LLC, Baltimore, MD (US)

(72) Inventors: Muniswamappa Anjanappa, Baltimore, MD (US); Xia Chen, Baltimore, MD (US); Ben Raab, Baltimore, MD (US); Ashwini Anjanappa, Baltimore, MD (US); Stephen Argo, Baltimore, MD (US); Manu Kemp Anjanappa, Baltimore, MD (US); Praveen Nayak, Baltimore, MD (US); Basavaraju B.N., Baltimore, MD (US)

(21) Appl. No.: 19/363,819

(22) Filed: Oct. 21, 2025

Related U.S. Application Data
(63) Continuation of application No. 18/304,972, filed on Apr. 21, 2023, now Pat. No. 12,447,592.
(60) Provisional application No. 63/333,193, filed on Apr. 21, 2022.

(51) Int. Cl. B25B 23/142

(52) U.S. Cl. CPC B25B 23/1425; B25B 23/1427

(57) ABSTRACT

An electronic torque wrench having a heat-treated hardened steel alloy spacer in a narrowed area of the wrench head. One end of the spacer is secured to one side of the narrowed area of the wrench head. A gap is provided between a free end of the spacer and an opposite side of the narrowed area. During operation of the tool within its rating, the gap remains open. However, when the rated torque is exceeded, the tool will begin to bend, closing the gap and causing the free end of the spacer to contact the adjacent face of the wrench head. The force of any additional torque applied is borne, at least in part, by the hardened torque-limiting spacer rather than by the wrench head.

### BACKGROUND OF THE INVENTION

### Field of the Invention

The present invention relates to hand tools and in particular to torque wrenches.

### Description of the Background

Often, fasteners used to assemble performance-critical components are tightened to a specified torque level to introduce a “pretension” in the fastener. For example, high tensile-strength steel bolts used to fasten components of military vehicles, aerospace vehicles, heavy machinery, and equipment for petrochemical operations frequently have required torque specifications. As torque is applied to the head of the fastener, eventually, beyond a certain level of applied torque, the fastener actually begins to stretch. This stretching results in pretension in the fastener which then holds the joint together. Overstressing fasteners can lead to their breakage whereas under-stressing bolts can lead to joint failure, leakage, etc. Furthermore, in situations where gaskets are being utilized between the components being joined, an unequally stressed set of fasteners can result in gasket distortion and subsequent problems like leakage.

In addition, it is now becoming common that an assembly specification requires the application of a specified torque followed by a further rotation of the fastener according to a specified angle of rotation. In such cases, application of the required torque takes place in two steps, (i) applying the specified torque followed by (ii) rotating the torque wrench tool by the specified angle. As an example, an assembly may call for applying 45 ft-lb followed by rotation of an additional 90 degrees. In such a case, the user might well select an electronic torque wrench rated for 100 ft-lb and proceed as follows:
1. Set the electronic torque wrench to the target torque of 45 ft-lb.
2. Apply torque until 45 ft-lb is displayed on the digital display.
3. Change the electronic torque wrench to “Angle mode.”
4. Set the Angle mode of the electronic torque wrench to the specified 90 degrees of additional rotation.
5. Rotate the electronic torque wrench until 90 degrees is displayed on the digital display.

Using a prior art electronic torque device to carry out these steps, the final torque applied might well be less than or equal to the tool's rated torque of 100 ft-lb. However, it is possible that the additional rotation of 90 degrees causes the final torque to exceed the rated torque of the tool, potentially damaging the tool, causing loss of accuracy and potentially rendering the tool unusable.

The present invention recognizes and addresses the foregoing considerations, and others, of prior art constructions.

### SUMMARY OF THE INVENTION

A new improved electronic torque wrench is therefore provided having a rated-torque-limiting spacer to prevent damage to sensitive parts of the tool when the tool is used over its rated torque. This invention addresses the problem of the prior art by providing a heat-treated hardened steel alloy spacer in a narrowed area of the wrench head. One end of the spacer is secured to one side of the narrowed area of the wrench head. A gap is provided between a free end of the spacer and an opposite side of the narrowed area. During operation of the tool within its rating, the gap remains open. However, when the rated torque is exceeded, the tool will begin to bend, closing the gap and causing the free end of the spacer to contact the edge of the wrench head that it faces. The force of any additional torque applied is borne, at least in part, by the hardened torque-limiting spacer rather than by the wrench head. At least one strain gage is provided to measure compression and tension on the narrowed area to confirm rated torque is not exceeded.

An enhanced visual display may optionally be provided with one or more of the following features: vivid colors, real-time dynamically scaled font sizes to minimize human error, and real-time changing background colors to indicate critical steps during application of torque and angle.

### BRIEF DESCRIPTION OF THE DRAWINGS

The foregoing summary, as well as the following detailed description of the preferred invention, will be better understood when read in conjunction with the appended drawings.

FIG. 1 is a schematic view of a torque wrench having a torque-limiting spacer to prevent damage to the device when applied torque exceeds the tool rating.

FIG. 2 is a schematic drawing showing a configuration of electronic controller hardware according to an embodiment of the invention.

Features in the attached drawings are numbered with the following reference numerals:

| | |
|---|---|
| 201 Rated-Torque-Limiting Spacer | 205 Spacer Gap |
| 203 Strain Gauge | |

### DETAILED DESCRIPTION OF THE INVENTION

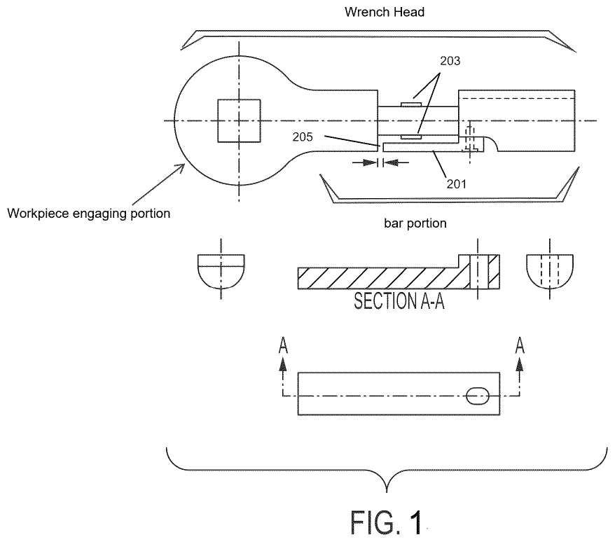

Referring to FIG. 1, the problem of exceeding the rated torque of an electronic torque wrench is solved by providing a strain gage 203 attached in a thinned out cross section of the wrench head and mounting a precision machined torque limiting spacer (“spacer”) 201 in the thinned out cross section with a small gap 205 between the spacer and adjacent face of the wrench head. The spacer is preferably made from heat-treated steel alloy. When the torque is applied, the wrench head is free to bend until it reaches its rated load. Once the rated torque is reached, the spacer is positioned and mounted so that the gap between the spacer and the adjacent surface closes with a direct metal to metal contact. The force of additional rotation is now shared with the spacer with the result that the thinned out cross section of the wrench head and the sensitive strain gage are prevented from exceeding the maximum rated torque for the tool.

There are two major advantages of the invention:
1. The safety and accuracy of the electronic torque wrench is improved because unknown final torque applied in a two-stage torque application (torque+angle) is mitigated once the torque exceeds the rated torque which can cause damage and loss of accuracy.
2. Since any load that exceeds the tool's rated torque is not taken exclusively by the thinned out cross section and sensitive strain gage, the cross-sectional area of the wrench head on which the strain gage is mounted may be decreased, thereby increasing the sensitivity and signal/noise ratio of the strain gage.

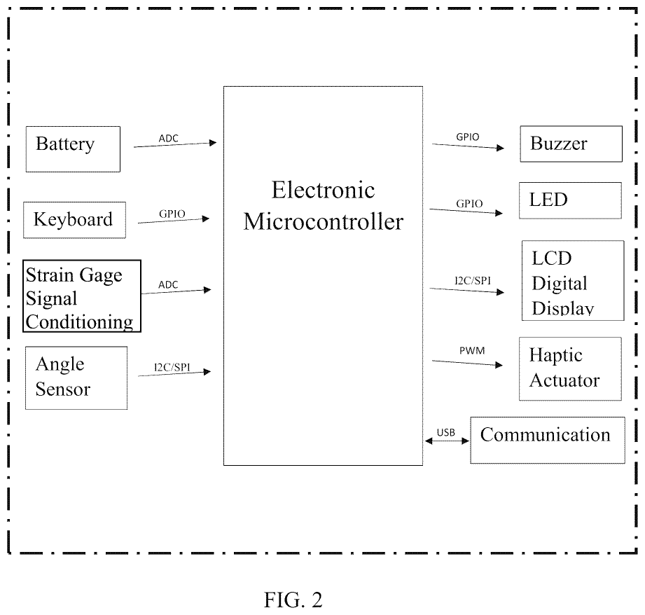

FIG. 2 is a block diagram representation of the electronic controller and associated elements of an electronic torque wrench according to the invention, including strain gage, MEMS Gyro IC with accelerometer output in X, Y, and Z directions. When torque is applied, deformation of the wrench head is sensed by the strain gage sensor which is then converted to a digital signal by a precision signal processing integrated circuit (“IC”). The microcontroller collects this information via built-in Analog-to-Digital Converter, computes the equivalent torque value and displays it on an LCD via I2C/SPI communication. When the rotation stage begins, the angle sensing MEMS Gyro IC senses all six-degrees of motion and converts to a standard format. The microcontroller collects the data, computes the specific one axis rotation angle and displays the angle value on the LCD via I2C/SPI communication.

According to a preferred embodiment, a color TFT LCD may be used as a displaying device, providing high contrast display, and optionally the following additional features and information:
Dynamic color display;
Significantly improved sunlight readability;
High visibility and dynamic size of numbers and icons;
Service alerts;
Instructional manual/Quick Start Guide; and
Service contact information.

In a typical two stage use (torque plus angle) of the device, the user will first select the target torque and then select the target angle by using the appropriate buttons on the keyboard. Before setting the torque and angle, the user can select the desired target torque unit (N·m, ft-lb, in-lb, kg·cm, etc) using the unit button on the keyboard.

During application of the specified torque, the electronic controller will closely monitor the safety of the unit by continuous measurement of the torque applied during the rotational angle application. If the measured torque reaches the rated torque of the tool, the electronic controller will immediately alert the user by means of visual, audible, and haptic signals so that the user can stop further application of the angle and avoid permanent damage to the tool. By way of specific example, as the measured torque reaches its target torque, the microcontroller may alert the operator with one or more of the following (i) LED lights starting with green, followed by yellow, and finally with red, (ii) haptic feedback by switching on a vibrating motor, and/or (iii) an audible sound by switching on a buzzer, indicating that the target torque has been reached. As with application of the specified torque, during angle application also the same three types of alert signals may be generated indicating that the target angle has been reached.

According to one optional feature, the electronic controller can keep track of all completed torque and angle applications. Based on the predetermined battery power draw for each such application, the electronic controller can cause the LCD to display the number of additional complete cycles of torque and/or angle applications that can be performed before a battery change is required.

Additional optional features include:
a. the electronic controller can communicate with external devices via USB port, facilitating data uploads and downloads;
b. data from the on-board MEMS Gyro IC built-in accelerometer can be used to detect if the unit has fallen/been dropped beyond a predetermined (e.g., ASME standard) safe height. If data shows that the unit has fallen more than the predetermined distance, the device can alert the user, recommending a calibration check;
c. a certification record can be generated for the torque and/or angle applied for each application and store it in the memory. The certificates can be downloaded via USB communication port, providing evidence of compliance with specified torque and/or angle;
d. a secondary strain gage sensor may be provided to measure the torque to provide improved accuracy/reliability;
e. a further strain gage may be provided in the plane perpendicular to the primary strain gage sensor(s). Data from the additional strain gage may be used to compensate for errors occurring due to misalignment of the tool during torque application. The primary strain gage senses the bending, but it is accurate only if the torque application results in pure bending, i.e., bending through a single plane and without twisting. Achieving a perfect pure bending is difficult at best and varies from user to user and fastener to fastener. Using one or more additional strain gages, especially in a plane perpendicular to the primary strain gage, can be used to account for and correct for any non-pure bending.

It will be appreciated by those skilled in the art that changes could be made to the preferred embodiments described above without departing from the inventive concept thereof. It is understood, therefore, that this invention is not limited to the particular embodiments disclosed, but it is intended to cover modifications within the spirit and scope of the present invention as outlined in the present disclosure and defined according to the broadest reasonable reading of the claims that follow, read in light of the present specification.

1.-17. (canceled)

18. A torque wrench for engaging a workpiece, comprising:
an elongated tube;
a wrench head including a workpiece engaging portion and a bar extending therefrom, said wrench head being secured to a first end of said elongated tube;
a hand grip located on a second end of said elongated tube;
said bar defining a narrowed portion and a hardened spacer fixedly attached to a first end of said narrowed portion and extending substantially across said narrowed portion to define a gap between a second end of said narrowed portion and a terminal face of said hardened spacer, wherein a length of said gap is configured so that when a rated torque of said torque wrench is exceeded, bending of said torque wrench causes said gap to close and said hardened spacer to bear a force of additional torque.

19. The torque wrench of claim 18, said elongated tube comprising an interior compartment, said bar extending into said interior compartment, and said workpiece engaging portion extending outwardly from said elongated tube.
